(19) United States
(12) Patent Application Publication
(10) Pub. No.: US 2026/0275940 A1
(43) Pub. Date: Sep. 17, 2026

(54) INTERMEDIATE CASING FOR A TURBINE ENGINE

(71) Applicant: SAFRAN AIRCRAFT ENGINES, Paris (FR)

(72) Inventors: Jérémy Philippe Pierre EDYNAK, Moissy-Cramayel (FR); François Marie Paul MARLIN, Moissy-Cramayel (FR); Cécile THIRIET, Moissy-Cramayel (FR); Mustapha HAMMOUCH, Moissy-Cramayel (FR)

(73) Assignee: SAFRAN AIRCRAFT ENGINES, Paris (FR)

(21) Appl. No.: 19/163,695

(22) PCT Filed: Mar. 14, 2024
(86) PCT No.: PCT/FR2024/050309

§ 371 Date: Sep. 9, 2025

(30) Foreign Application Priority Data
Mar. 14, 2023 (FR) FR2302356

(51) Int. Cl. F02K 3/075; F01D 25/24; F02K 3/06; F02K 3/077

(52) U.S. Cl. CPC F02K 3/075; F01D 25/24; F02K 3/06; F02K 3/077; F05D 2240/14; F05D 2260/606

(57) ABSTRACT

An assembly for a turbine engine including an intermediate casing with a primary duct portion, a tertiary duct portion, an intermediate hub, an inter-duct shroud, an outer shroud, structural arms connecting the intermediate hub and the outer shroud, and an exhaust duct extending between the primary duct and the tertiary duct, and bypass valves capable of drawing fluid from the primary duct portion in order to direct it toward the exhaust duct. The intermediate casing is formed as a single piece and has a cavity located between the intermediate hub and the inter-duct shroud that opens onto the upstream face of the intermediate casing via an opening, wherein the bypass valves are able to be inserted into the cavity via the opening.

The present invention relates to a three-flow propeller turbine engine, and more specifically to an assembly comprising an intermediate casing of such a turbine engine.

A three-flow propeller turbine engine extending along a longitudinal axis X comprises, upstream to downstream (in the normal direction of air flow during operation) a hub whose rotating section carries a ring of blades forming the propeller. This rotating section is supported by a shaft rotated by a gas generator. This shaft extends along the longitudinal axis X. An inner casing coaxial with the hub is located outside the hub and downstream of the propeller. An outer casing coaxial with the hub is located outside the inner casing and also downstream of the propeller. The upstream end of the outer casing is upstream of the upstream end of the inner casing.

The hub and the inner casing each have an upstream part and a downstream part. An intermediate casing, also referred to as the “inter-compressor casing” is located between the upstream parts of the hub and the inner casing on the one hand, and the downstream parts of the hub and the inner casing on the other hand. This intermediate casing is attached to both the upstream and downstream parts of the hub and of the inner casing, and extends in a plane that is transverse (i.e. perpendicular) to the longitudinal axis X. The intermediate casing comprises a hub, referred to as the intermediate hub, an inter-stream shroud, an outer shroud, and structural arms connecting the intermediate hub and the outer shroud. The purpose of the intermediate casing is to meet the structural, mechanical and flexibility requirements of the engine, to absorb the forces from the bearings located near this intermediate casing, to absorb the forces of connecting rods, to support the attachment of the accessory gearboxes (AGBs) and the attachment of various equipment. The outer shroud, also referred to as the “VCI”, is mounted on the intermediate hub by means of the structural arms which are radial. The intermediate casing comprises a downstream flange on its downstream side, and an upstream flange on its upstream side.

During normal operation, an air flow (referred to as the secondary flow) circulates outside the hub and outer casing. An annular primary flow stream extends between the outer casing and the hub, and then between the inner casing and the hub. This primary flow stream opens downstream, at its outlet, into the gas generator. A primary flow circulates in this primary flow stream, which primary flow supplies air to the gas generator during normal operation of the turbine engine. The primary flow stream passes through the intermediate casing.

The space between the inner casing and the outer casing defines a tertiary flow stream that is located radially outside the primary flow stream. The upstream inlet of this tertiary flow stream is located in the primary flow stream at the upstream end of the inner casing. This tertiary flow stream leads downstream, at its outlet, into the atmosphere. The tertiary flow stream passes through the intermediate casing. The turbine engine further comprises an exhaust duct which extends between the primary flow stream and the tertiary flow stream. The exhaust duct is also referred to as the “bypass duct”.

An assembly for a turbine engine is therefore known, which assembly consists, on the one hand, of an intermediate casing extending along a longitudinal axis, this intermediate casing comprising a primary flow stream portion, a tertiary flow stream portion, an intermediate hub, an inter-stream shroud, an outer shroud, structural arms connecting the intermediate hub and the outer shroud, and on the other hand an exhaust duct which extends between the primary flow stream and the tertiary flow stream, and bypass valves capable of drawing fluid from the primary flow stream portion and directing it towards the exhaust duct.

French patent document FR3012846B1 describes an example of bypass valves mounted on an intermediate casing of a twin-spool turbine engine.

The primary flow stream has side openings through which the bypass valves are mounted in the intermediate casing.

The intermediate casing provided with bypass valves has a significant weight, which results in increased fuel consumption, which is undesirable. Furthermore, the presence of a primary flow stream and tertiary flow stream complicates the assembly and maintenance of the bypass valves.

### DESCRIPTION OF THE INVENTION

The present invention aims to overcome these drawbacks.

The invention relates to an intermediate casing provided with bypass valves whose structure is improved in order to be both lighter and more practical for the assembly and maintenance of the bypass valves.

This aim is achieved by the fact that the intermediate casing is made in one piece and has a cavity located between the intermediate hub and the inter-stream shroud, which cavity opens out at the upstream face of the intermediate casing via an opening located between the intermediate hub and the inter-stream shroud, the bypass valves being capable of being inserted into the cavity through this opening.

Thanks to these arrangements, in particular the fact that the intermediate casing is made in one piece, the assembly of the intermediate casing is simplified. The weight of the intermediate casing is reduced compared to an intermediate casing wherein the outer shroud is removable from the intermediate hub, because it is no longer necessary to use flanges for attaching the outer shroud to the intermediate hub. The presence of a cavity in the intermediate casing to house the bypass valves and which opens out at the upstream face via an opening through which the bypass valves can be inserted makes it easier to assemble and maintain these bypass valves.

Advantageously, the surface area of the opening is greater than 50% of the total surface area of the part of the upstream face located between the intermediate hub and the inter-stream shroud.

Thus, a greater variety of bypass valves can be housed in the cavity in the intermediate casing.

Advantageously, the intermediate casing is devoid of any upstream flange on its upstream face.

This simplified access to the bypass valves, making it easier to house the bypass valves. This also limits dimensions outside the manufacturing tolerance in the context of the machining operations to be carried out to attach these bypass valves. Moreover, the overall weight of the intermediate casing is reduced.

The invention further relates to a turbine engine comprising a hub which supports a propeller, an outer casing, an inner casing located radially outside the hub, and an outer casing located radially outside the inner casing, the primary flow stream extending between the hub and the inner casing and having an upstream inlet located downstream of the propeller, the tertiary flow stream extending radially outside the primary flow stream between the inner casing and the outer casing and having an upstream inlet that is located in the primary flow stream at the upstream end of the inner casing, the turbine engine comprising an assembly according to the invention.

For example, the propeller is ducted by an annular nacelle.

The invention further relates to a method for mounting bypass valves in an intermediate casing of an assembly according to the invention, such that each of the bypass valves is inserted into the cavity through the opening.

The invention will be better understood and its advantages will appear more clearly upon reading the following detailed description of embodiments given as non-limiting examples. The description refers to the accompanying drawings, in which:

FIG. 1 is a diagrammatic, longitudinal sectional view of a turbine engine according to the invention.

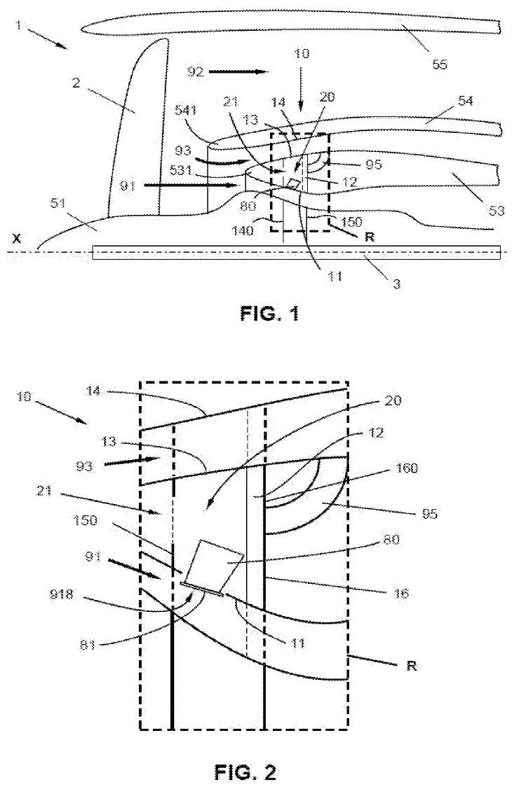

FIG. 2 is a view of the region R in FIG. 1 showing the intermediate casing.

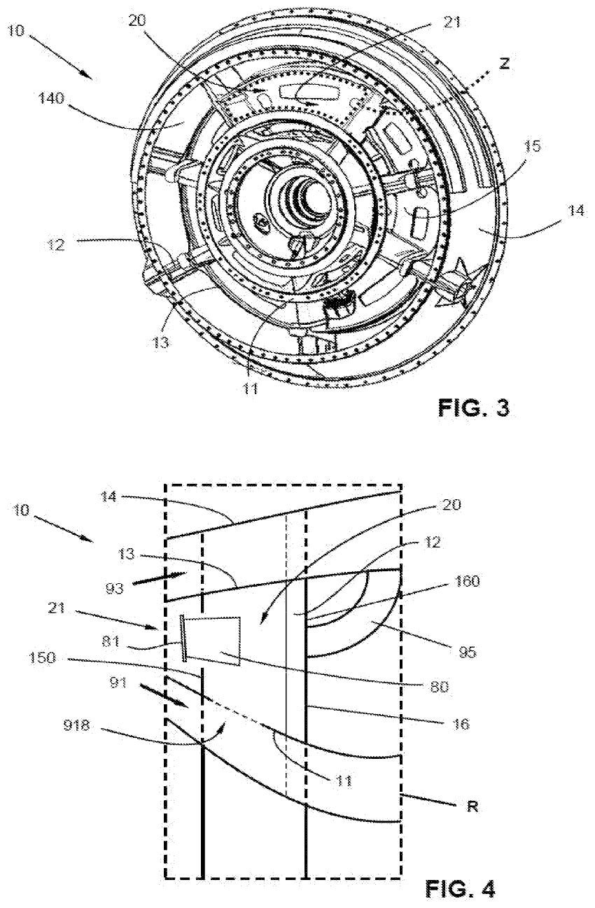

FIG. 3 is a perspective view of an intermediate casing of an assembly according to the invention.

FIG. 4 is a diagrammatic, longitudinal sectional view of an intermediate casing of an assembly according to the invention showing the insertion of a bypass valve into its cavity.

### DETAILED DESCRIPTION OF THE INVENTION

In the following description, FIG. 1 is a diagrammatic, longitudinal sectional view of a three-flow turbine engine 1 with a propeller 2 according to the invention (the part of the turbine engine 1 that is the furthest downstream is not shown). The turbine engine 1 is shown for the case of a propeller 2 ducted by an annular nacelle 55. Alternatively, the propeller 2 is unducted. The turbine engine 1 extends along a longitudinal axis X. This turbine engine 1 comprises, from upstream to downstream (i.e. in the normal direction of air circulation during operation) a hub 51 whose rotating section supports a ring of blades forming the ducted propeller 2. This rotating section is supported by a shaft 3 rotated by a gas generator (not shown). This shaft 3 extends along the longitudinal axis X. The hub 51 is composed, along the longitudinal axis X, of rotating sections and static sections. An inner casing 53 coaxial with the hub 51 is located outside the hub 51 and downstream of the propeller 2. An outer casing 54 coaxial with the hub 51 is located outside the inner casing 53 and also downstream of the propeller 2. The upstream end 541 of the outer casing 54 is upstream of the upstream end 531 of the inner casing 53. The hub 51 and the inner casing 53 each have an upstream part and a downstream part.

An intermediate casing 10, also referred to as the “inter-compressor casing”, is located between the upstream parts of the hub 51 and the inner casing 53 on the one hand, and the downstream parts of the hub 51 and the inner casing 53 on the other hand. This intermediate casing 10 is attached on the one hand to the upstream part and to the downstream part of the hub 51, and on the other hand to the upstream part and to the downstream part of the inner casing 53, and extends in a plane that is transverse (i.e. perpendicular) to the longitudinal axis X.

In normal operation, an air flow (referred to as the secondary flow) circulates outside the hub 51 and the outer casing 54. This secondary flow circulates in a secondary flow stream 92, the radially inner wall whereof is formed by the outer surface of the outer casing 54 and the radially outer wall whereof is formed by the inner surface of the nacelle 55. Thus, the nacelle 55 is located radially outside the outer casing 54. An annular primary flow stream 91 extends between the outer casing 54 and the hub 51, and then between the inner casing 53 and the hub 51. This primary flow stream 91 opens up downstream, at its outlet, into the gas generator. A primary flow circulates in this primary flow stream 91, which primary flow supplies air to the gas generator during normal operation of the turbine engine 1. The turbine engine comprises a tertiary flow stream 93 which extends between the inner casing 53 and the outer casing 54, and which is therefore located radially externally relative to the primary flow stream 91. The upstream inlet of this tertiary flow stream 93 is located in the primary flow stream 91 at the upstream end of the inner casing 53. This tertiary flow stream 93 leads downstream, at its outlet, into the atmosphere. A tertiary flow circulates in this tertiary flow stream 93.

The primary flow stream 91 and the tertiary flow stream 93 pass through the intermediate casing 10. In other words, the intermediate casing 10 delimits a portion of the primary flow stream 91 and a portion of the tertiary flow stream 93. The intermediate casing 10 comprises a central intermediate hub 11 that is centered on the longitudinal axis X, an inter-stream shroud 13, an outer shroud 14, and structural arms 12 that connect the intermediate hub 11, the inter-stream shroud 13 and the outer shroud 14. The inner casing 53 comprises a part of the central intermediate hub 11 and the inter-stream shroud 13. At the intermediate casing 10, the walls of the primary flow stream 91 are formed by the central intermediate hub 11. At the intermediate casing 10, the radially inner wall of the tertiary flow stream 93 is formed by the inter-stream shroud 13, and the radially outer wall of the tertiary flow stream 93 is formed by the outer shroud 14. The outer shroud 14 is part of the outer casing 54. The intermediate casing 10 has an upstream face 150 and a downstream face 160 (see FIG. 2). For example, the intermediate casing 10 has a downstream flange 16 on its downstream face 160, which flange is located downstream of the arms 12.

The intermediate casing 10 is made in one piece, which makes it easier to manufacture and reduces its weight. This is because there is no need to assemble the inter-stream shroud 13, the outer shroud 14 and the intermediate hub 11.

The intermediate casing is provided with an exhaust duct 95 which extends between the primary flow stream 91 and the tertiary flow stream 93. For example, the exhaust duct 95 consists of a plurality of separate individual exhaust ducts. For example, each of these exhaust ducts has a rectangular cross-section. Reference will be made to an exhaust duct 95 in order to designate either an individual duct or all of these exhaust ducts.

An assembly is defined, consisting of the intermediate casing 10, this exhaust duct 95 and a plurality of bypass valves 80 which are distributed circumferentially about the longitudinal axis X. The bypass valves 80 are capable of drawing part of the fluid flowing in the primary flow stream 91 and directing it to the tertiary flow stream 93 via the exhaust duct 95. The description of the environment and operation of a bypass valve 80 is given below, which description applies to each of the bypass valves 80. FIG. 2 is an enlarged view of the region R in FIG. 1, which illustrates the intermediate casing 10, the exhaust duct 95 and one of the bypass valves 80.

The radially outer wall of the primary flow stream 91 comprises a side opening 918 that brings the primary flow stream 91 and the exhaust duct 95 into fluid communication through the bypass valve 80. The side opening 918 is located on the intermediate hub 11. The bypass valve 80 comprises a gate 81 which is capable of switching between a closed position wherein it closes the side opening 918 and an open position wherein it opens this side opening 918. In the closed position, the primary flow stream 91 is isolated from the exhaust duct 95. In the open position, the fluid is able to circulate from the primary flow stream 91 into the bypass valve 80 and then into the exhaust duct 95.

The intermediate casing 10 has a cavity 20 located between the intermediate hub 11 and the inter-stream shroud 13, which cavity opens out at the upstream face 150 of the intermediate casing 10 via an opening 21. The cavity 20 is therefore located at the inner casing 53. The cavity 20 is a part of the exhaust duct 95, and is thus partially defined by the intermediate hub 11 and the inter-stream shroud 13. For example, the cavity 20 forms a continuous space. For example, the cavity 20 is partially or totally divided by the structural arms 12. The bypass valves 80 are capable of being housed in the cavity 20. The opening 21 is located between the intermediate hub 11 and the inter-stream shroud 13. The opening 21 is annular. For example, the opening 21 consists of a plurality of openings separated by the structural arms 12.

Each bypass valve 80 is inserted into the cavity 20 through the opening 21 in order to be housed in this cavity 20. Each bypass valve 80 is positioned such that the gate 81 closely fits the side opening 918 of the primary flow stream 91.

The dimension of the opening 21 at the upstream face 150 between the intermediate hub 11 and the inter-stream shroud 13 is sufficient to allow the bypass valves 80 to be passed and mounted in the cavity 20. Subsequent maintenance of the bypass valves 80 is also made easier. This is because this configuration allows tools used to attach and maintain the bypass valves 80 to pass through the opening 21. For example, these tools are used to machine raised portions such as bosses on the intermediate hub 11 in order to enable the bypass valves 80 to be attached.

Thus, the surface area of the opening 21 is greater than 50% of the total surface area of the part of the upstream face 150 located between the intermediate hub 11 and the inter-stream shroud 13. For example, the radial height of the opening 21 at the upstream face 150 is greater than 10 centimeters.

According to one embodiment of the invention, the intermediate casing 10 is devoid of any upstream flange (this upstream flange being normally mounted on the upstream face 150). The total weight of the intermediate casing 10 is thus reduced. The mechanical tests carried out by the inventors show, surprisingly, that the absence of an upstream flange does not adversely affect the mechanical performance of the intermediate casing 10. In other words, an intermediate casing 10 without any upstream flange has mechanical properties that exceed the required properties. FIG. 3 is a perspective view of the intermediate casing 10 of this embodiment. For the sake of clarity, the bypass valves 80 have not been illustrated. The area Z of the opening 21 between two structural arms 12 is diagrammatically illustrated using dashed lines. It should be noted that the absence of any upstream flange makes it possible to free up (clear), on the upstream face 150 of the intermediate casing 10, a wider opening 21 (i.e. an opening that is wider than it would be if the intermediate casing 10 had an upstream flange) for inserting the bypass valves 80 into the cavity 20.

The invention further relates to a method by which a bypass valve 80 is inserted into the cavity 20 through the opening 21.

FIG. 4 diagrammatically illustrates a longitudinal section of an intermediate casing 10 with a bypass valve 80 during the insertion thereof into the cavity 20 through the opening 21.

In FIG. 2, the bypass valve 80 is diagrammatically illustrated in its final position in the cavity 20. The gate 81 is illustrated in the position wherein it almost fully closes the side opening 918 of the primary flow stream 91.

1. An assembly for a turbine engine comprising an intermediate casing extending along a longitudinal axis, said intermediate casing comprising a primary flow stream portion, a tertiary flow stream portion an exhaust duct extending between said primary flow stream and said tertiary flow stream, an intermediate hub, an inter-stream shroud, an outer shroud structural arms connecting said intermediate hub and said outer shroud, and said assembly further comprising an exhaust duct extending between said primary flow stream and said tertiary flow stream and bypass valves capable of drawing fluid from said primary flow stream portion and directing it towards said exhaust duct, wherein said intermediate casing is formed as a single piece and has a cavity located between said intermediate hub and said inter-stream shroud, which cavity opens out onto the upstream face of said intermediate casing via an opening located between said intermediate hub and said inter-stream shroud, said bypass valves being able to be inserted into said cavity through said opening

2. The assembly according to claim 1, wherein the surface area of said opening is greater than 50% of the total surface area of the part of said upstream face located between said intermediate hub and said inter-stream shroud.

3. The assembly according to claim 1, wherein said intermediate casing is devoid of any upstream flange on its upstream face.

4. A turbine engine comprising a hub which supports a propeller, an inner casing located radially outside said hub, and an outer casing located radially outside said inner casing, said primary flow stream extending between said hub and said inner casing and having an upstream inlet located downstream of the propeller, said tertiary flow stream extending radially outside said primary flow stream between said inner casing and said outer casing and having an upstream inlet that is located in said primary flow stream at the upstream end of said inner casing, said turbine engine comprising an assembly according to claim 1.

5. The turbine engine according to claim 4, wherein said propeller is ducted by an annular nacelle.

6. A method for mounting bypass valves in an intermediate casing of an assembly according to claim 1, wherein each of said bypass valves is inserted into said cavity through said opening.
